(19) United States
(12) Patent Application Publication
(10) Pub. No.: US 2005/0257977 A1
(43) Pub. Date: Nov. 24, 2005

(54) DRIVE CONTROL DEVICE FOR ELECTRIC VEHICLE

(75) Inventor: Satoshi Kamiya, Mori-Machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-Machi (JP)

(21) Appl. No.: 10/908,086

(22) Filed: Apr. 27, 2005

(30) Foreign Application Priority Data
May 20, 2004 (JP) 2004-149913

(51) Int. Cl. B60K 31/18

(52) U.S. Cl. 180/171

(57) ABSTRACT

An electric powered vehicle and warning system wherein changes in operator demand and vehicle speed are monitored and warning is given to the operator when it is sensed or determined that the sensed speed may be in error.

### BACKGROUND OF INVENTION

This invention relates to an electrically driven vehicle and control device and method therefore.

There are a wide variety of electrically driven vehicles and they are put to a wide variety of purposes and travel over or in various terrains. In many of these applications it is desirable to control their operation automatically to avoid potentially dangerous situations. By way of example, golf carts are often electrically powered for environmental and other reasons.

As is well known, a golf cart travels over varying terrains having both moderate and steep grades. It is common, therefore, to provide some form of speed limiting device so that the speed will not become to grate for the condition, regardless of the operator demand. For example to avoid over speed when going down a steep grade.

Such a speed limiter obviously requires a sensor for determining vehicle speed. Generally the speed sensor cooperates with a driven shaft or wheel and is comprised of a device that generates electrical pulses the number of which in a determined time interval indicates vehicle speed. Such a system is shown in Japanese Published application Hei 10-309005 (A).

However both the environment over which the vehicle operates and other factors such as shocks encountered when riders get on or off the vehicle or place or remove loads from the vehicle may cause the speed sensor or its connections to become damaged or fail totally. This obviously can cause false or incorrect signals resulting in an undesirable condition.

It is, therefore, a principal object of this invention to provide an apparatus and methodology that will monitor the output of a vehicle speed sensor and compare it with the operator's speed demands and give a warning to the operator when the sensor output is deemed to be erroneous.

### SUMMARY OF THE INVENTION

A first feature of the invention is adapted to be embodied in a vehicle having a propulsion device driven by an electric motor. The vehicle has a rider operated speed control for controlling the driving speed of the electric motor. There is also a device for providing signals indicating the vehicle traveling speed. Devices sense both changes in the position of the rider operated speed control and changes in the indicated vehicle speed in respective time periods. A warning operation is performed when the vehicle speed change in the time period is equal to a first value or greater and the change in position of the rider operated speed is a second value or less.

Another feature of the invention is adapted to be embodied in a warning method for a vehicle having a propulsion device driven by an electric motor. The vehicle has a rider operated speed control for controlling the driving speed of the electric motor. There is also a device for providing signals indicating the vehicle traveling speed. The method comprises the steps of sensing both changes in the position of the rider operated speed control and changes in the indicated vehicle speed in respective time periods. A warning operation is performed when the vehicle speed change in the time period is equal to a first value or greater and the change in position of the rider operated speed is a second value or less.

### BRIEF DESCRIPTION OF THE DRAWINGS

FIG. 1 is a partially schematic top elevational view of an electric powered vehicle constructed and operated in accordance with the invention.

FIG. 2 is a schematic electrical diagram of the vehicle and its control.

FIG. 3 is a diagram showing the conditions for determining vehicle speed sensor variations and operator vehicle control position variations on increases in speed determination.

FIG. 4 is a diagram showing the conditions for determining vehicle speed sensor variations and operator vehicle control position variations on decreases in speed determination.

FIG. 5 is a block diagram showing the control methodology.

### DETAILED DESCRIPTION

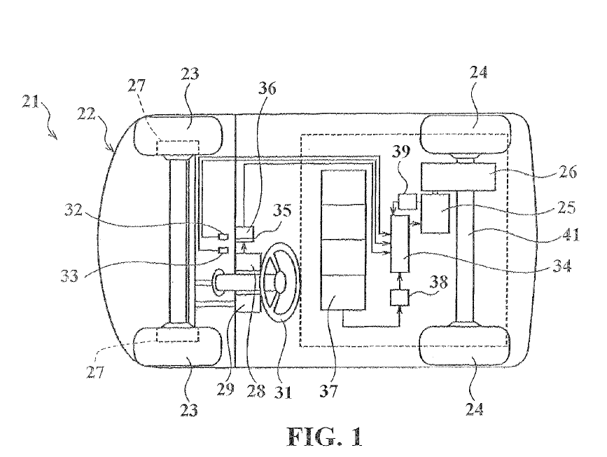

Referring now in detail to the drawings and initially to FIG. 1, an electrically powered vehicle such as a golf cart, as an example of vehicle with which the invention may be practiced is identified generally by the reference numeral 21. This golf cart 21 is provided with a body, frame 22 that rotatably supports in any desired manner paired front wheels 23 and rear wheels 24. In the illustrated embodiment, the rear wheels 24 are driven by a shunt type electric motor 25 through a transmission 26. Associated with some or all of the wheels 23 and 24 (only the front wheels 23 in the illustrated embodiment) are brakes 27 of any desired type.

An operator may be seated on a suitable seat (neither of which are shown) behind an accelerator pedal 28, for controlling the speed of the electric motor 25, a brake pedal 29, for operating the wheel brakes 27, and a steering wheel 31, for steering the front wheels 23 in any desired manner.

Also juxtaposed to the operator's position is a main switch 32, and a direction control switch 33, for controlling the direction of travel of the golf cart 21 by controlling the direction of rotation of the motor 25. The main switch 32 and the direction control switch 33 are connected to a controller 34. Operation of the accelerator pedal 28 is transmitted to an on off pedal switch 35 and an accelerator opening degree sensor 36 connected to the controller 34, to send on or off state of the accelerator 28 and its degree of opening to the controller 34.

A plurality of batteries 37 (48 V in total, for example) as power sources are mounted suitably on the body frame 22 and are connected through a relay 38 to the controller 34.

A vehicle speed sensor 39 is provided in association with the electric motor 25 and generates a high-frequency pulse signal according to the rotational speed of the motor 25 and the signal is inputted into the controller 34. Alternatively the vehicle speed sensor 39 may be associated with any vehicle wheel or other shaft that drives a wheel such as a rear axle 41.

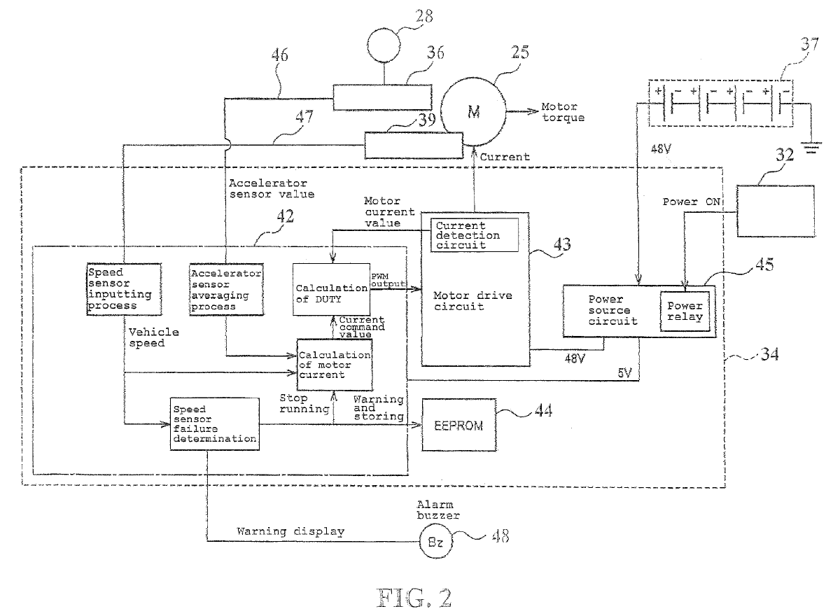

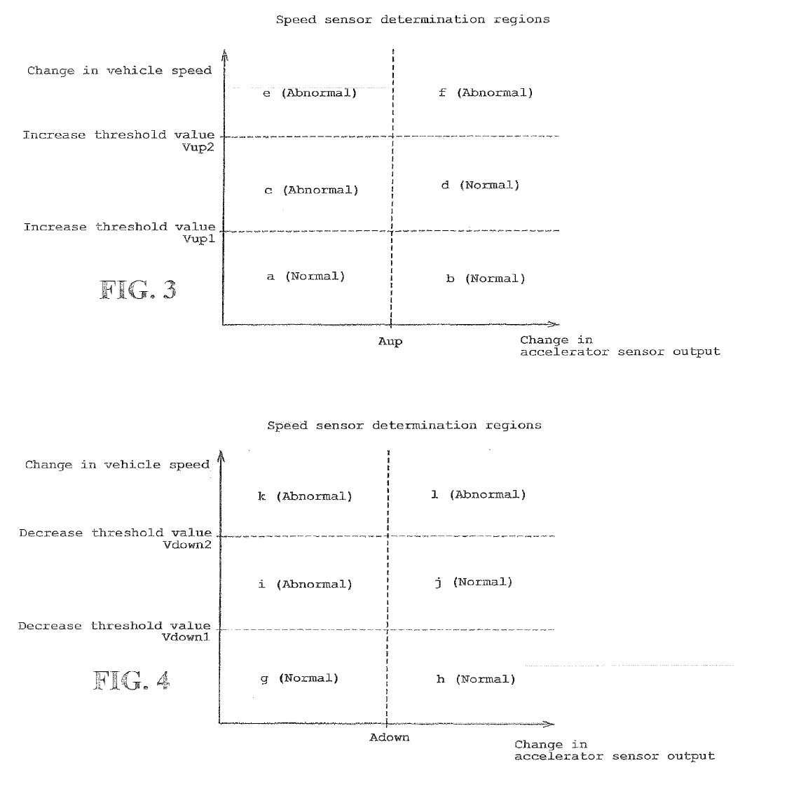

The configuration of a drive control device according to the present invention for the golf cart 21 will now be described by reference to FIG. 2. The drive control device is comprised mainly the speed sensor 39 and the controller 34 for detecting a sensor failure based on the output condition of the speed sensor 39 and performing the processes described later by reference to FIGS. 3-5.

As has been noted, the accelerator opening degree sensor 36 is operatively connected to the accelerator pedal 28 and outputs a voltage corresponding to the amount the accelerator pedal is depressed by the driver to the controller 34. The controller 34 has a processing unit (MPU) 42, indicated by the broken line box, that receives a speed signal (high frequency pulse) and an accelerator position signal (voltage) from the speed sensor 39 and the accelerator opening degree sensor 36, respectively. The processing unit 42 performs calculations for driving the motor 25 through a motor drive circuit 43 for outputting current for driving the motor 25. Also the processing unit 42 transfers data to a memory (EEPROM) 44 for storing data, as will be described later.

A power source circuit 45 supplies power from the batteries 37 to the processing unit (MPU) 42, the motor drive circuit 43, and the accelerator opening degree sensor 36. In this embodiment, the power source circuit 45 supplies 48 volts to the motor drive circuit 43 and 5 volts to the processing unit 42 when the main switch 32 is turned on.

Signals from the accelerator opening degree sensor 36 are delivered to the processing unit 42 via a signal line 46, and signals from the speed sensor 39 are delivered to the processing unit 42 via a signal line 47.

The processing unit 42, as indicated by the boxes in FIG. 2, performs a speed sensor failure determination process, and obtains an average of accelerator opening degree sensor values (accelerator opening degree sensor averaging process), calculates a motor driving current and a duty ratio using the accelerator average value and provides them as PWM outputs to the motor drive circuit 43. The motor drive circuit 43 has a function of detecting the motor driving current currently outputted (current detection circuit), and the detected motor current value is provided as feedback to the processing unit 42.

The system also has a device for issuing a warning to the operator of the golf cart 21 such as an alarm buzzer 48 for warning the driver when the speed sensor has a failure determined as will be described later by reference to FIGS. 3-5. The alarm buzzer 48 is connected to the processing unit 42, which performs a sensor failure determination process.

If the signal line 47 connected to the speed sensor 39 has a break or the speed sensor 39 shows a value different from the actual running speed due to the influence of noise or other disturbances, the controller 34 of this embodiment can find the failure immediately, and stop the golf cart 21 and warns the driver of the failure with the alarm buzzer 48.

More specifically, the controller 34 monitors the changes in the vehicle speed value obtained from the speed sensor 39 compared with changes in the displacement of the accelerator pedal 28, that is, the output value from the accelerator opening degree sensor 36 and the direction of the accelerator pedal 28 (acceleration or deceleration). Then, when the change in the vehicle speed within a short period of time does not correspond to the change in the output from the accelerator opening degree sensor 36, the controller 34 determines that the speed sensor 39 has a failure.

Referring next to FIG. 3, this schematically illustrates the regions in which the speed sensor is determined to be normal or abnormal relation to the change in the accelerator opening degree sensor output and the change in the vehicle speed during acceleration. In this embodiment, two threshold values Vup1 and Vup2 are set in the increase of the vehicle speed and a threshold value Aup is set in the increase of the accelerator opening degree sensor output as shown in the drawing, and the speed sensor is determined to be normal or abnormal based on a plurality of operation regions indicated at “a” to “f” and defined by the threshold values Vup1, Vup2 and Aup.

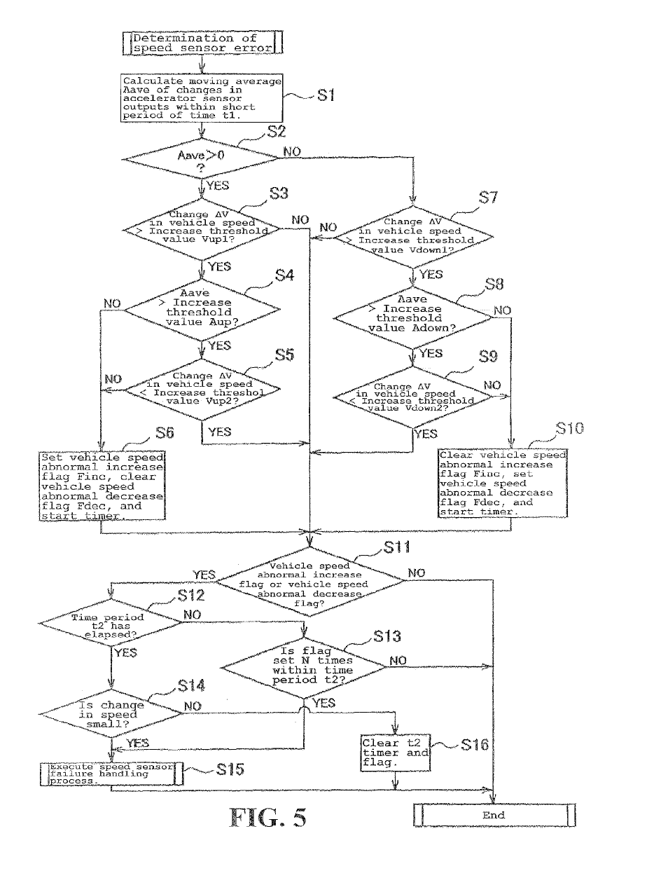

In a similar manner FIG. 4 schematically illustrates the regions in which the speed sensor is determined to be normal or abnormal in the relationship between the change in the accelerator opening degree sensor output and the change in the vehicle speed during deceleration. As in the case of acceleration, two threshold values Vdown1 and Vdown2 are set in the decrease of the vehicle speed and a threshold value Adown is set in the decrease of the accelerator opening degree sensor output. The speed sensor is determined to be normal or abnormal based on a plurality of operation regions indicated by “g” to “l” and defined by the threshold values Vdown1, Vdown2 and Adown.

The control routine will now be described by reference to FIG. 5. The program for performing the flowchart is stored in a memory in the controller 34 and executed every predetermined time period t1 (5 ms. for example) by the processing unit 42. The program starts at the step S1 where the displacement of the accelerator pedal position per one cycle of this routine, that is, the moving average Aave of the changes in the accelerator opening degree sensor outputs within a short period of time t1 is calculated.

Then at the step S2 it is determined whether the accelerator opening degree sensor moving average Aave obtained in step S1 is a positive value, which indicates that the vehicle is accelerating, or a negative value, which indicates that the vehicle is decelerating. If the accelerator opening degree sensor moving average Aave is greater than 0 (Yes), it is determined that the vehicle is accelerating, and the routine goes to step S3. If the accelerator opening degree sensor moving average Aave is smaller than 0 (No), it is determined that the vehicle is decelerating, and the routine goes to step S7.

Assuming that the operator is calling for an increase in speed, at the step S3 it is determined if vehicle is operating in a generally allowable acceleration range. Thus, a threshold value Vup1 is set as a first acceleration threshold value and the vehicle speed is obtained from the speed sensor 39. Then, it is determined whether the change AV in the vehicle speed within the short period of time t1 (acceleration) is greater than the threshold value Vup1. If the change ΔV is greater than the threshold value Vup1 (Yes), the vehicle determines that there is a possibility that the speed sensor has a failure and the routine goes to step S4. If the change ΔV is smaller than the threshold value Vup1 (No), it is determined that the output from the speed sensor is normal. Then, the routine skips the following steps and goes to step S11. That is, within the regions “a” and “b” in FIG. 3 described before correspond to this.

At the step S4 id is determined whether the driver has depresses the accelerator pedal 28 quickly or relatively slowly depending on the conditions under which the golf cart is used. Here, it is determined whether the accelerator was depressed quickly. More specifically, a threshold value Aup of the increase in the accelerator opening degree sensor output is set as a boundary between quick and slow depressions, and it is determined whether the moving average Aave calculated in step S1 is greater than the threshold value Aup. If the moving average Aave is greater than the threshold value Aup (Yes), there is a possibility that the accelerator pedal was depressed quickly by the driver. In this case, the routine goes to step S5. If the moving average Aave is smaller than the threshold value Aup (No), since the increase in the accelerator opening degree sensor output is small although the golf cart 21 is accelerated quickly, it is determined that the output from the speed sensor 39 is abnormal. Then, the routine skips the following step S5 and goes to step S6. This is the vehicle condition corresponding to the region “c” in FIG. 3.

If the operator has depressed the accelerator pedal 28 quickly, at the step 5 it is determined if the vehicle speed calculated from the output value from the speed sensor 39 may show an abnormal value because of a failure of the speed sensor 39. Thus, it is determined whether the change ΔV in the vehicle speed calculated in the process of step S3 is attributed to a quick depression of the accelerator pedal. This is done by setting a second threshold value Vup2 is set as an increase in the speed based on an appropriate change in the vehicle speed corresponding to such a “quick depression” obtained in advance by experiment. Then it is determined whether the change ΔV in the vehicle speed (acceleration) is smaller than this second threshold value Vup2.

If at the step S5 the change ΔV is smaller than the second threshold value Vup2 (Yes), it is determined that this increase in the vehicle speed is attributed to a “quick depression” of the accelerator pedal by the driver and the output from the speed sensor 39 is normal. Then, the routine skips step S6 and goes to step S11. This is the operating condition corresponding to the region “d” in FIG. 3.

However if at the step S5 it is determined that the change ΔV is greater than the second threshold value Vup2 (No), that is, when the output from the accelerator opening degree sensor 36 shows a rapid increases (since the result is “Yes” in step S4) and the change ΔV in the vehicle speed (acceleration) obtained from the speed sensor 39 is too large even if the increase is taken into account, it is determined that there is a possibility that the speed sensor has a failure.

In this case, the routine goes to step S6. This is the vehicle condition corresponding to the regions “e” and “f” in FIG. 3. The failure determination in step S5 is made by comparing the change in the vehicle speed and the second threshold value Vup2 regardless of the change in the output from the accelerator opening degree sensor 36. Thus, when the accelerator opening degree sensor 36 has a failure and the information from the accelerator opening degree sensor 36 is unreliable, it is possible to make a determination whether the speed sensor 39 has a failure. This is determined at the step S11, as will be described later. In this case, a vehicle speed abnormal increase flag Finc is set to 1 and a vehicle speed abnormal decrease flag Fdec is cleared to 0. At the same time, a timer for counting the time which has elapsed after the flag setting is started.

Returning back now to step S2, if the determination is made that the operator of the cart 21 is calling for deceleration, the program moves to the step S7 where it is determined if the cart 21 has a generally allowable deceleration range, the same as was done in the case of accelerating. Thus, a threshold value Vdown1 is set as a first deceleration threshold value and the vehicle speed is obtained from the speed sensor 39. From this information, it is determined whether the change ΔV in the vehicle speed within the short period of time t1 (deceleration) is greater than the threshold value Vdown1.

If the change ΔV is greater than the threshold value Vdown1 (Yes), the controller 34 determines that there is a possibility that the speed sensor has a failure and the routine goes to step S8. If the change ΔV is smaller than the threshold value Vdown1 (No), it is determined that the output from the speed sensor 39 is normal. Then, the routine skips the following step S8 and goes directly to step S10. That is, the cart 21 is operating in the regions “g” and “h” in FIG. 4.

The driver releases his/her foot from the accelerator pedal 28 depending on the running conditions. However, when the driver quickly releases the accelerator pedal 28 for a very short period of time such as 5 msec during running, the vehicle speed does not suddenly decreased to zero.

This condition is determined at the step S8. Here, in order to determine whether the driver quickly released the accelerator pedal 28, it is determined whether the moving average Aave of the accelerator opening degree sensor 36 calculated in step S1 is greater than a predetermined decrease threshold value Adown indicating an appropriate decrease in the accelerator opening degree sensor output.

If the moving average Aave of the accelerator opening degree sensor 36 is greater than the decrease threshold value Adown (Yes), there is a possibility that the driver quickly released the accelerator pedal 28. Then, the routine goes to step S9. If the moving average Aave of the accelerator opening degree sensor 36 is smaller than the decrease threshold value Adown (No), that is, when the accelerator opening degree sensor output shows a small decrease (that is, gentle deceleration) although it is determined that the golf cart 21 was quickly decelerated, it is determined that the output from the speed sensor 39 is abnormal. Then, the routine skips step S9 and goes directly to step S10. This is the vehicle condition corresponding to the region “i” in FIG. 4.

If the program has moved to the step S9 from the step S8 because the driver released the accelerator pedal 28 to decelerate the vehicle quickly, the vehicle speed will not decreased to zero within a short period of time. However, if the signal line 47 of the speed sensor 39 has a break, the output from the speed sensor 39 is fixed to a high or low level and, consequently, the calculated vehicle speed becomes zero. Thus at the step S9 it is determined whether the change ΔV calculated in the process in step S3 is attributed to a release of the accelerator pedal. More specifically, a second threshold value Vdown2 is set as a decrease in the speed based on an appropriate change in the vehicle speed corresponding to such a “quick release” obtained in advance by experiment, and it is determined whether the change ΔV in the vehicle speed (deceleration) is smaller than the second decrease threshold value Vdown2.

If the change ΔV is smaller than the second decrease threshold value Vdown2 (Yes), it is determined that this decrease in the vehicle speed is attributed to a “quick release” of the accelerator pedal by the driver and the output from the speed sensor 39 is normal. Then, the routine skips step S10 and goes directly to step S11. This is the vehicle condition corresponding to the region “j” in FIG. 4.

However if the change ΔV is greater than the second decrease threshold value Vdown2 (No), that is, when the output from the accelerator opening degree sensor 36 shows a rapid decreases (since the result is “Yes” in step S8) and the change ΔV in the vehicle speed (deceleration) obtained from the speed sensor 39 is too large even if the decrease is taken into account, it is determined that there is a possibility that the speed sensor has a break. Then, the routine goes to step S10. This is the vehicle condition corresponding to the regions “k” and “l” in FIG. 4. The failure determination in step S9 is made by comparing the change in the vehicle speed and the second threshold value Vdown2 regardless of the change in the output from the accelerator opening degree sensor 36 as in the case with step S5. Thus, when the accelerator opening degree sensor 36 has a failure and the information from the accelerator opening degree sensor 36 is unreliable, it is possible to make a determination whether the speed sensor 39 has a failure.

At the step S10, the vehicle speed abnormal increase flag Finc is cleared to 0 and a vehicle speed abnormal decrease flag Fdec is set to 1 in contrast to step S6. At the same time, the timer for counting the time which has elapsed after the flag setting is started.

Referring now to the condition the routine has moved to the step S11 from any of steps S3, S5, S6, S7, S9 or S10, the current set or clear state of the flags is checked. In this program, the vehicle speed abnormal increase flag Finc and the vehicle speed abnormal decrease flag Fdec are set or cleared depending on the change in the speed within a short period of time.

As has already been noted, if the signal line 47 of the speed sensor 39 has a break and the output pulse from the sensor 39 suddenly disappears (the vehicle speed becomes zero), since no change in the speed is detected in the routine after the flag Finc or Fdec has been set to 1 at the time of a change in the speed, “No” is selected in step S3 or S7 and the routine has gone to step S11. If the vehicle speed abnormal increase flag Finc or the vehicle speed abnormal decrease flag Fdec has not set (No), the routine skips the following step S12 and comes to an end.

However, if the vehicle speed abnormal increase flag Finc or the vehicle speed abnormal decrease flag Fdec is set to 1 (Yes), the routine goes to step S12. In this step, a predetermined time period t2 (for example, a time period corresponding to 200 cycles when the execution interval of this routine is 5 msec) is set as a flag set continuation time. Then it is determined whether the time period t2 has elapsed after the first flag setting. If the time period t2 has elapsed after the flag setting (Yes), the routine goes to step S14. If the time period t2 has not elapsed yet (No), the routine goes to step S13.

When the signal line 47 of the speed sensor 39 has a break or the connection is interrupted repeatedly the vehicle speed as the calculation product shows sudden changes within a short period of time. Thus, at the step S13 it is determined whether the vehicle speed abnormal increase flag Finc or the vehicle speed abnormal decrease flag Fdec is set N times, that is, so many times that it is determined that chattering is occurring, within the time period t2. If the vehicle speed abnormal increase flag Finc or the vehicle speed abnormal decrease flag Fdec is not set N times (No), the routine is terminated.

Returning now to the step S12, if the result was positive (yes) the program moves to the step S14. When the number of times the vehicle speed abnormal increase flag Finc or the vehicle speed abnormal decrease flag Fdec is set does not reach the number N within the time period t2 and there is a large change in the speed during that period (within the time period t2 after the first flag setting), it is considered that the flag was set because the speed sensor 39 picked up noise. Thus, in this step, it is determined whether the flag setting is attributed to noise by comparing the change ΔV in the speed obtained in step S3 and a preset small value. If there is a change in the speed (No), it is determined that the flag setting is caused by noise, and the routine goes to step S16.

The flag setting caused by noise is not a failure of the speed sensor 39. Thus, it is determined at the step S16 that the speed sensor is normal and the vehicle speed abnormal increase flag or the vehicle speed abnormal decrease flag, which has been set, is reset and the timer for counting the time which has elapsed after the flag setting is cleared. Then, the routine is terminated.

However if at the step S14 that the change in the speed is small (Yes), it is considered that the signal line 47 of the speed sensor 39 has a break, and the routine goes to step S15 where a speed sensor failure handling process is executed. For example, the calculation of motor current in the processing unit 42 is stopped to stop the vehicle, and the alarm buzzer 48 shown in FIG. 2 is activated to inform the driver of the sensor failure. Also, the occurrence of the sensor failure is recorded in an EEPROM 44 of the controller 34 as a failure history of the golf cart 21.

The foregoing steps are executed in the processing unit 42 of the control device 34 according to this embodiment. In this embodiment, the change in the vehicle speed obtained from the speed sensor 39 is monitored based on the change in the output value from the accelerator opening degree sensor 36 and the direction of the accelerator pedal (acceleration or deceleration) every short period of time. Then, when the vehicle speed detected by the speed sensor 39 has a change greater than a preset value, and when the vehicle speed does not have a change for a predetermined period of time after the change (Yes in step S14) or the number of times of changes in the vehicle speed within a predetermined period of time is greater than a preset value (Yes in step S13), it is determined that the speed sensor 39 has a failure. Then, the vehicle is stopped and the occurrence of the failure is informed to the driver. Thus, the golf cart, unlike a conventional golf cart, does not fall into a golf cart speed control mode based on erroneous information and is not decelerated so quickly that the driver feels uncomfortable. Further, in this embodiment, as a condition for determining whether or not the speed sensor has a failure, a change in the vehicle speed after a predetermined period of time after a speed sensor failure flag has been set is checked and, if there is a speed change, the speed sensor failure flag is reset. Thus, an erroneous failure handling process caused by noise picked up by the sensor can be excluded.

Although the present invention has been described taking a drive control device which determines a failure of the speed sensor based on the relationship between the change in the vehicle speed and the change in the output from an accelerator opening degree sensor, the present invention is not limited to the example and can be variously modified. For example, the numbers of threshold values as shown in FIG. 3 and FIG. 4 may be increased to divide the regions for use in the determination of a failure of the speed sensor into smaller regions. In the flowchart in the embodiment, the change in the vehicle speed calculated from the speed sensor output value is used as one parameter for determination of a failure of the speed sensor. In addition to this, a step in which the speed sensor 39 detects the current vehicle speed and the calculation of the vehicle speed is stopped if the pulse frequency (vehicle speed) obtained from the speed sensor output value exceeds the maximum motor rotational speed (that is, the maximum vehicle speed) obtained from the battery voltage may be provided. Of course those skilled in the art will readily understand that the described embodiments are only exemplary of forms that the invention may take and that various changes and modifications may be made without departing from the spirit and scope of the invention, as defined by the appended claims.

1. A vehicle having a propulsion device driven by an electric motor, a rider operated speed control for controlling the driving speed of said electric motor, a sensor for providing signals indicating the speed said vehicle is traveling speed, a sensor for sensing changes in the position of the rider operated speed control, a comparator for comparing changes in the position of said rider operated speed control and changes in the indicated vehicle speed in respective time periods, and a warning device for providing a warning signal when sensed the vehicle speed change in the time period exceeds a first value and the sensed change in position of the rider operated speed control is a less than a second value.

2. A vehicle as set forth in claim 1 wherein the warning signal is an audible signal.

3. A vehicle as set forth in claim 1 wherein the warning signal comprises a cessation of operation of the electric motor.

4. A vehicle as set forth in claim 1 wherein the warning signal is also given when sensed the vehicle speed change in the time period is less than a third value and the sensed change in position of the rider operated speed control is a greater than a fourth value.

5. A vehicle as set forth in claim 4 wherein the warning signal is also given if vehicle speed change exceeds a predetermined amount regardless of any change in the position of the rider operated speed control.

6. A vehicle as set forth in claim 1 wherein the warning signal is also given if vehicle speed change exceeds a predetermined amount regardless of any change in the position of the rider operated speed control.

7. A sensor failure warning method for vehicle having a propulsion device driven by an electric motor and a rider operated speed control for controlling the driving speed of the electric motor, said method comprising the steps of sensing the speed the vehicle is traveling speed, sensing changes in the position of the rider operated speed control, comparing changes in the position of the rider operated speed control and changes in the vehicle speed in respective time periods, and providing a warning signal when sensed the vehicle speed change in the time period exceeds a first value and the sensed change in position of the rider operated speed control is a less than a second value.

8. A vehicle warning method as set forth in claim 7 wherein the warning signal is an audible signal.

9. A vehicle warning method as set forth in claim 7 wherein the warning signal comprises a cessation of operation of the electric motor.

10. A vehicle warning method as set forth in claim 1 wherein the warning signal is also given when sensed the vehicle speed change in the time period is less than a third value and the sensed change in position of the rider operated speed control is a greater than a fourth value.

11. A vehicle warning method as set forth in claim 10 wherein the warning signal is also given if vehicle speed change exceeds a predetermined amount regardless of any change in the position of the rider operated speed control.

12. A vehicle warning method as set forth in claim 7 wherein the warning signal is also given if vehicle speed change exceeds a predetermined amount regardless of any change in the position of the rider operated speed control.
